(19) United States
(12) Patent Application Publication
(10) Pub. No.: US 2004/0021790 A1
(43) Pub. Date: Feb. 5, 2004

(54) Method of and system for processing image information on writing surface including hand-written information

(76) Inventor: Soichiro Iga, Tokyo (JP)

Correspondence Address: KNOBLE & YOSHIDA, LLC, Eight Penn Center, Suite 1350, 1628 John F. Kennedy Blvd., Philadelphia, PA, 19103, US

(21) Appl. No.: 10/449,352

(22) Filed: May 30, 2003

(30) Foreign Application Priority Data
May 31, 2002 (JP) 2002-160645

(51) Int. Cl. H04N 5/222

(52) U.S. Cl. 348/333.12

(57) ABSTRACT

The image is rendered on a conventional image writing surface such as a whiteboard or a portable writing pad device. The image is captured by a scanner or a CCD camera, and the digitized image data is analyzed for automatically generating separate image objects such as text areas, picture areas and so on. These image objects are now displayed for the user to edit information. For example, the user defines relational links between images and or image objects. Based upon the edited information, a document is generated for later retrieval and information dissemination.

### FIELD OF THE INVENTION

The current invention is generally related to a writing device, and more particularly related to a method of and a system for image processing the information on the writing device including hand-written information.

### BACKGROUND OF THE INVENTION

Whiteboards and blackboards have been used for various situations. For example, agendas and decisions are confirmed by using the whiteboards or blackboards in meetings. Similarly, the whiteboards and blackboards are used to display descriptive diagrams in conferences. Among these boards, like Ricoh Co. Ltd's Imagiard™, there are so-called electric whiteboards and electric blackboards. These electric boards often include an image board switching function as well as an image storing function by scanning a writing surface.

A number of systems have been proposed to process an image that has been stored from hand-written images on the whiteboard or the blackboard. For example, these systems have been disclosed by Q. Stafford-Fraser in “BrightBoard: A Video-Augmented Environment,” Technical Report EPC-1995-108, Rank Xerox Research Center (1995) and by E. Saund in “Bringing the Marks on a Whiteboard to Electronic Life,” Proc. Of CoBuild '99, pp 69-78 (1999). In the above disclosed systems, when a user writes a predetermined symbol by a marker pen on the whiteboard, a computer is activated and a camera takes an image of the whiteboard. Based upon certain image recognition technology, the predetermined symbol written by the marker pen is detected from the image. Furthermore, another disclosure includes “Things that see: machines Perception for Human Computer Interaction,” by J. Coutaz, J. L. Crowley, and F. Berard in Communications of ACM, Vol. 43, No. 3, March (2000). In the second disclosed system, a movable camera takes an image from the whiteboard, and a projector projects an image onto the whiteboard.

In the above prior technologies, a system stores image data from a rendered image on the whiteboard and the blackboard and processes the stored image data. Among the above described examples; an exemplary system for processing the stored image from the writing surface of a writing device such as a whiteboard automatically generates document data that includes the stored image and image portions as an electric document to be displayed on a display unit.

Among the stored images and image portions in the stored images, there is often some sort of relationships. For example, if “first agenda” and “second agenda” are written on the whiteboard, they are stored as an image. Subsequently, if “conclusion of first agenda” and “conclusion of second agenda” are stored as an image from the whiteboard, there is a relationship of the corresponding agenda and conclusion between the images. Furthermore, there is a relationship between the image portions such as “the first agenda and its conclusion,” “the second agenda and its conclusion” and “the first agenda and the second agenda.”

When the document containing images or image portions is generated and is displayed it is desired that the user can access an image or an image portion that is related to a current image or image portion. For this reason it is desired that the system user selects the automatic access between the images and or the image portion before the document data is generated.

### SUMMARY OF THE INVENTION

In order to solve the above and other problems, according to a first aspect of the current invention, a method of information processing, including the steps of: inputting on an image drawing surface an image containing at least one image object, a predetermined set of image types being defined for the image objects; automatically determining an area and a image type for each of the image objects; displaying a display object for representing each of the image objects; editing information on the image objects based upon the display object, the information including a relational link between the image objects; and generating document data for the image according the edited information on the image objects, the image objects and the image type.

According to a second aspect of the current invention, a system for information processing, including: an image inputting unit having a conventional image drawing surface for drawing an image containing at least one image object, a predetermined set of image types being defined for the image objects; a processing unit connected to the image inputting unit for automatically determining an area and a image type for each of the image objects and for displaying a display object for representing each of the image objects; an editor connected to the processing unit for editing information on the image objects based upon the display object, the information including a relational link between the image objects; and a document generating unit connected to the processing unit for generating document data for the image according the edited information on the image objects, the image objects and the image type.

According to a third aspect of the current invention, a method of retrofitting a conventional image inputting device for further image processing, including the steps of: placing an image capturing device near the conventional image inputting device; inputting on an image drawing surface of the conventional image inputting device an image containing at least one image object, a predetermined set of image types being defined for the image objects; capturing the image in a predetermined digitized data format; automatically determining an area and a image type for each of the image objects based upon the digitized data; displaying a display object for representing each of the image objects; editing information on the image objects based upon the display object, the information including a relational link between the image objects; and generating document data for the image according the edited information on the image objects, the image objects and the image type.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram illustrating a preferred embodiment of the writing board document management system according to the current system.

FIG. 2 is a block diagram illustrating components or soft modules of the computer 101 in the preferred embodiment according to the current invention.

FIG. 3 is a diagram illustrating the image processing unit 201 and the automatic area labeling unit 202 of the preferred embodiment according to the current invention.

FIG. 4A is diagram illustrating an exemplary input image 401, which includes a circular drawing object 411, a triangular drawing object 412, a rectangular drawing object 413, a reflective light portion 414, a non-drawing object 415 and a background portion 416.

FIG. 4B is a diagram illustrating the removal of the noise from the input image 401 by the noise removing unit 301.

FIG. 4C is a diagram illustrating the binarization of the noise-free image by the binarizing unit 302.

FIG. 4D is a diagram illustrating the quantization of the binarized image is by the quantizing unit 303.

FIG. 4E is a diagram illustrating that the automatic area labeling unit 202 determines a first specified area A 451, a second specified area B 452 and a third specified area C 453.

FIG. 5A is a list illustrating a point data structure, POINTAPI that specifies a particular point.

FIG. 5B is a list illustrating a line data structure, myLines that specifies a particular line.

FIG. 5C is a list illustrating an area data structure, myRegion for storing the data for an area.

FIG. 5D is a list illustrating an image data structure, myImage for storing the area data.

FIG. 6 is a flow chart illustrating steps involved in one preferred process of information processing by the noise removing unit 301 according to the current invention.

FIG. 7 is a flow chart illustrating steps involved in one preferred process of information processing by the quantizing unit 303 according to the current invention.

FIG. 8 is a flow chart illustrating steps involved in one preferred process of information processing by the automatic labeling unit 202 according to the current invention.

FIG. 9 is a flow chart illustrating steps involved in a preferred process of recursion by the visit function according to the current invention.

FIG. 10 is a flow chart illustrating steps involved in a preferred process of automatic labeling by the automatic area labeling unit 202 according to the current invention.

FIG. 11 is a diagram illustrating a graphical user interface (GUI) for the user to input data into the computer 101 in the preferred embodiment according to the current invention.

FIG. 12 is a diagram illustrating a process of moving a display position of the image recognition information 1101 (D) and the area recognition information 1102 (E).

FIG. 13 is a diagram illustrating a process of changing the image recognition information 1101 (F) and the area recognition information 1102(G).

FIG. 14 is a diagram illustrating a process of editing labels for the image recognition information 1101 (H) and 1101 (I) as well as the area recognition information 1102 (H1), 1102 (H2) and 1102(I1).

FIG. 15 is a diagram illustrating a process where a new area is generated as a part of the input image by adding new area recognition information 1102 (J1) as a part of the image recognition information 1101 (J).

FIG. 16A is a diagram illustrating a process of linking between the input images, between the areas of different input images and between the areas of the same input image.

FIG. 16B is a diagram illustrating a process of linking a display object 1220 for the image link 1118 and another display object 1121 for an area link 1119.

FIG. 17 a diagram illustrating one example of adding a character string 1122 to the input image of the image recognition information 1101 (N) after the user draws “HOMEWORK.”

FIGS. 18A and 18B are diagrams illustrating the zoom sliders 1112 and 1113 along with other display objects.

FIGS. 19A is a list illustrating a structure that defines a variable, scale in a double precision floating point (Double).

FIG. 19B is a list illustrating an exemplary structure for the input image, mImg(0) in which the position of the input image is multiplied by the scale variable, “scale” for displaying in the window area 1103.

FIG. 20 is a flow chart illustrating steps involved in one preferred process of converting the document data into the HTML format according to the current invention.

FIG. 21A is a list illustrating the data structure for the HTML header contains information to indicate that the current document is a HTML document.

FIG. 21B is a list illustrating the data structure for the CSS description added to each area of the HTML document.

FIG. 21C is a list illustrating the data structure for the area.

FIG. 21D is a list illustrating the data structure for the area.

FIG. 22A is a diagram illustrates that the hypertext registering unit 208 displays the HTML formatted document 1126 stored in the hard disk 209 on the Web browser 108.

FIG. 22B is a diagram illustrating the view of the HTML document 1126 as generated and then saved in the above described manner.

FIG. 23A is a diagram illustrating one preferred embodiment of the multi-functional machine 2301 including a writing pad device 2302 that is equipped with the computer 101 and the CCD camera 103.

FIG. 23B is a diagram illustrating a second preferred embodiment of the multi-functional machine 2301 including the writing pad device 2302 that is equipped with the computer 101 and the CCD camera 103.

FIG. 23C is a diagram illustrating a third preferred embodiment of the multifunctional machine 2301 including the writing pad device 2302 that is equipped with the computer 101 and the CCD camera 103.

FIG. 23D is a diagram illustrating a fourth preferred embodiment of the multi-functional machine 2301 including the writing pad device 2302 that is equipped with the computer 101 and the CCD camera 103.

FIG. 24 is a diagram illustrates an alternative embodiment of the system of FIG. 1, where the CCD camera 103 is replaced by the scanner 110 according to the current invention.

FIG. 25A is a diagram illustrating that the program 2501 has been already installed in a hard disk 2503 in the computer 2502 and will be provided to the computer 2502 from the hard disk 2503.

FIG. 25B is a diagram illustrating that the program 2501 is temporarily or permanently stored in a recording medium 2504 and will be provided to the computer 2502 by inserting the recording medium 2504.

FIG. 25C is a diagram illustrating examples of the recording medium 2504, and the examples include a floppy® disk 2505, a compact disk for read only memory (CD-ROM) 2506, a magnet optical disk (MO) 2507, a magnetic disk 2508, a digital versatile disk (DVD) 2509 and a semi conductor memory 2510.

FIG. 25D is a diagram illustrating a download of the program 2501 to a computer.

FIG. 26 is a diagram illustrating the directionality of the relational links between the image objects according to the current invention.

### DETAILED DESCRIPTION OF THE PREFERRED EMBODIMENT(S)

Based upon incorporation by external reference, the current application incorporates all disclosures in the corresponding foreign priority document (Japanese Patent Application Serial No. 0200249, filed on May 31, 2002) from which the current application claims priority.

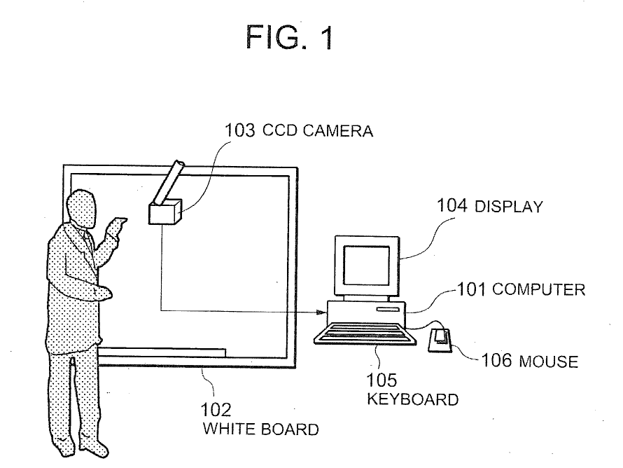

Referring now to the drawings, wherein like reference numerals designate corresponding structures throughout the views, and referring in particular to FIG. 1, a preferred embodiment of the writing board document management system according to the current system is illustrated. The preferred embodiment includes a computer or processing unit 101 and peripheral devices such a whiteboard 102, a CCD camera 103, a display 104, a keyboard 105 and a mouse 106. On the surface of the whiteboard 102, the user can draw objects such as characters and diagrams using a writing instrument such as a marker pen. The CCD camera 103 is located at a position to take an image of the writing surface of the whiteboard 102. The computer 101 processes the image data that has been captured from the writing surface by the CCD camera 103. The CCD camera 103, the display 104, the keyboard 105 and the mouse 106 are all connected to the computer 101.

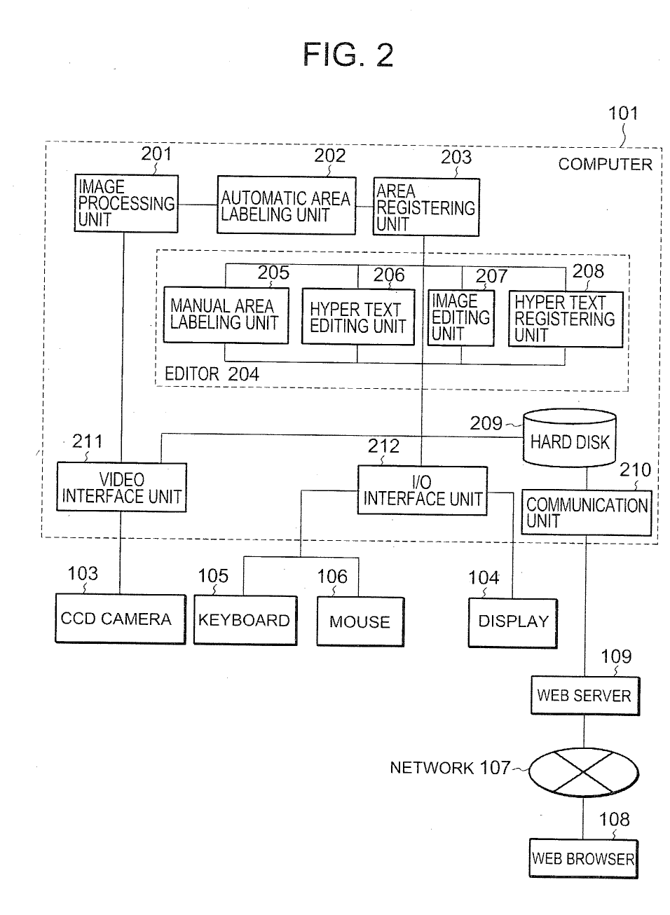

Now referring to FIG. 2, a block diagram illustrates components or soft modules of the computer 101 in the preferred embodiment according to the current invention. The computer 101 further includes an image processing unit 201, an automatic area labeling unit 202, an area storing unit 203, an editor 204, a manual area labeling unit 205, a hyper text editing unit 206, a drawing editor 207, a hypertext generating or registering unit 208, a hard disk 209, a communication unit 210, a video interface unit 211 and an I/O interface unit 212. The image data that has been captured by taking an image of the drawing surface of the whiteboard 102 by the CCD camera 103 is inputted into the computer 101 via the video interface unit 211, which performs the analog-to-digital (A/D) conversion. For example, the color image data includes red, green and black components of 8-bit pixel values. The image data is further inputted into the image processing unit 201, which processes the inputted image data. The image processes of the image processing unit 201 will be later described. The processed image data is inputted into the automatic area labeling unit 202. The automatic area labeling unit 202 determines based upon the processed image data an area that is occupied by the drawing objects in the input image and places a corresponding label to each of the specified areas and the input image. The detailed processes of the automatic area labeling unit 202 will be later described.

The data associated with the areas and the labels is temporarily stored in the area storing unit 203 along with the input images and the corresponding labels. For example, the area storing unit 203 is implemented by a random access memory (RAM). In response to a user input, the data associated with the areas and the labels as well as the input images and the corresponding labels are edited by the manual area labeling unit 205 of the editor 204. That is, a user manually edits the data associated with the areas and the labels as well as the input images and the corresponding labels. The hyper text editing unit 206 of the editor 204 builds structures from the data on the input images and the areas stored in the area storing unit 203 in accordance with the user input. The structuralization means hypertext referencing among or between the area data and the input image data in the area storing unit 203. Furthermore, the drawing editor 207 of the editor 204 adds a new drawing object to the input image in the area storing unit 203 in accordance with a user input. That is, the user manually adds a new drawing object to the input image in the area storing unit 203. A hypertext storing unit 208 of the editor 204 converts the structuralized input image data and the structuralized area data from the hyper text editing unit 206 into the hypertext markup language (HTML) format so that they can be seen by a world-wide Web browser 108. The converted HTML data is stored in the hard disk 209. The document in the hard disk 209 is accessible through the network and the communication unit 210. The document is referenced as a structural document through the world-wide Web browser 108 via the Web server 109. The user input for the editor 204 is inputted to the computer 101 through the keyboard 105 or the mouse 106 via the I/O interface 212. The information for the user input is outputted from the computer 101 to the display 104 via the I/O interface 212.

(1) Information Processing For Area Specification

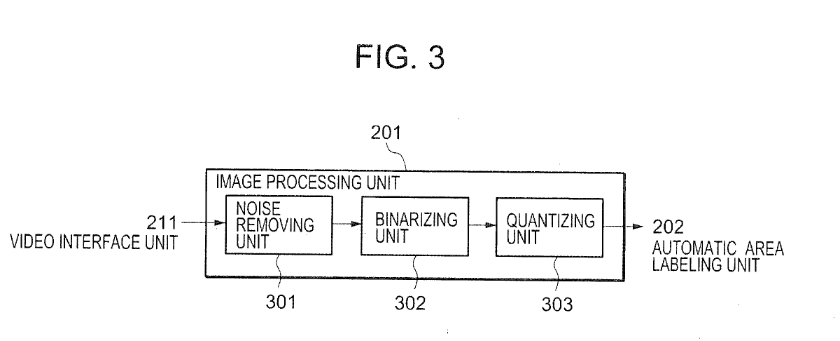

Referring to FIG. 3, the image processing unit 201 and the automatic area labeling unit 202 of the preferred embodiment will be further described according to the current invention. The image processing unit 201 further includes a noise removing unit 301, a binarizing unit 302 and a quantizing unit 303. The noise removing unit 301 removes noise from the input image. The binarizing unit 302 binarizes the input image while the quantizing unit 303 quantizes it. As a result of the above processes, the input image is converted into a converted image.

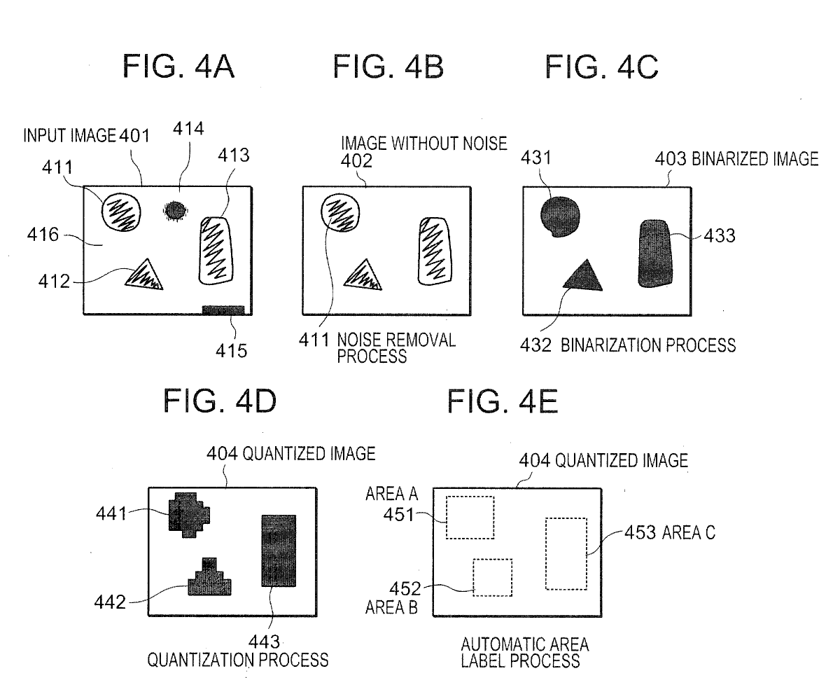

Now referring to FIGS. 4A through 4E, the above processes are further described. FIG. 4A illustrates an exemplary input image 401, which includes a circular drawing object 411, a triangular drawing object 412, a rectangular drawing object 413, a reflective light portion 414, a non-drawing object 415 and a background portion 416. As shown in an image 402 in FIG. 4B, the noise has been removed from the input image 401 by the noise removing unit 301. After the noise removing unit 301 has removed the reflective light portion 414 and the non-drawing object 415, the input image 402 has retained the circular drawing object 411, the triangular drawing object 412 and the rectangular drawing object 413. As shown in an image 403 in FIG. 4C, the noise-free image is now binarized by the binarizing unit 302. The binarized image now includes binarized versions of the circular drawing object 431, the triangular drawing object 432 and the rectangular drawing object 433.

Subsequently, as shown in an image 404 in FIG. 4D, the binarized image is now quantized by the quantizing unit 303. The quantizing unit 303 qunatizes the binarized circular drawing object 431, the binarized triangular drawing object 432 and the binarized rectangular drawing object 433 respectively into the quantized circular drawing object 441, the quantized triangular drawing object 442 and the quantized rectangular drawing object 443. The quantizing unit 303 converts the above binarizing objects 431, 432 and 433 by using a predetermined size of blocks so the quantized image 404 is processed by the predetermined grids. Finally, the quantized image 404 is outputted by the image processing unit 201 and inputted into the automatic area labeling unit 202. The automatic area labeling unit 202 specifies areas that the quantized drawing objects 441, 442 and 443 occupy based upon the quantized image 404. As shown in an image 404 in FIG. 4E, the automatic area labeling unit 202 determines a first specified area A 451, a second specified area B 452 and a third specified area C 453 that respectively correspond to the quantized circular drawing object 441, the quantized triangular drawing object 442 and the quantized rectangular drawing object 443. As a result of the above described processes, the original drawing objects in the input image 401 are now specified by the quantized image 404. For the areas occupied by the drawing objects 411, 412 and 413 in the input image 401, the input image 401 and the data for specifying the areas occupied by the drawing objects 411, 412 and 413 are stored in the area storing unit 203. For example, the coordinates for the upper left corner and the lower right corner of the areas 451, 452 and 453 from the quantized image 404 are stored. The above described stored area data is called “area data” hereinafter in relation to the further description of the current invention.

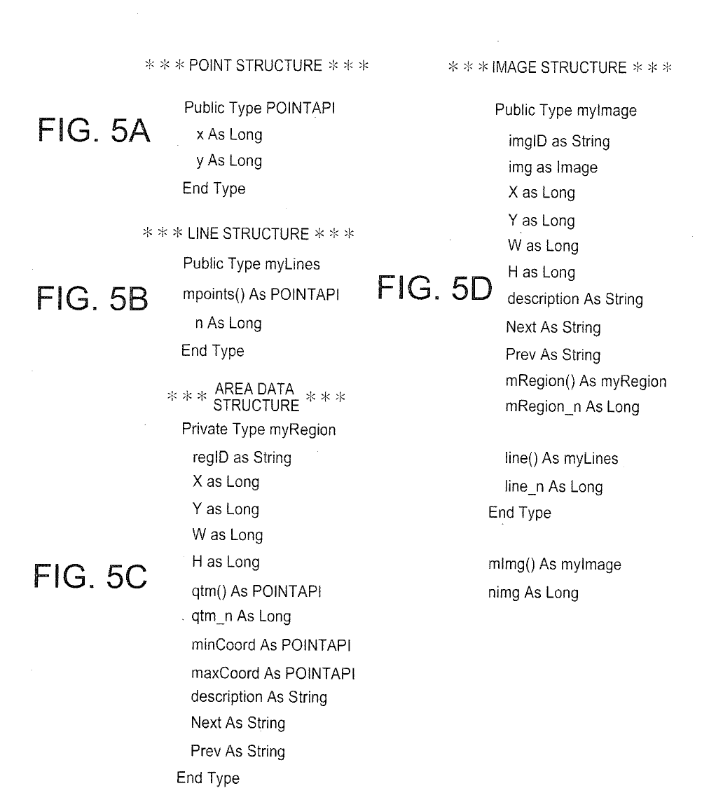

Now referring to FIGS. 5A through 5D, a data structure is respectively illustrated for a point, a line, an area and an image for use in the preferred embodiment according to the current invention. FIG. 5A illustrates a point structure, POINTAPI that specifies a particular point. The variable, “As Long” is an integer variable. “x” is a variable for the x coordinate while “y” is a variable for the y coordinate. FIG. 5B illustrates a line structure, myLines that specifies a particular line. The variable with a “0” value is a variable having group elements. Mpoints( ) is a variable for storing a point as a variable. FIG. 5C illustrates an area data structure, myRegion for storing the data for an area. The variable, “As String” is a character string variable while “regID” is a variable for storing an ID for an area. X is a coordinate in the x axis while Y is a coordinate in the y axis. W is a length of the area in the x direction while H is a length of the area in the y direction. qtm( ) is a variable for storing a working point as a group element. qtm_n ( ) is an index variable for qtm( ). minCoord is a variable for storing an upper left corner of the area. maxCoord is a variable for storing a lower right corner of the area. “description” is a variable for storing a label for the area that is edited by the user. Next is a variable for storing the next area that is linked from the current area. Prev is a variable for storing a previous area that is linked to the current area. FIG. 5D illustrates an image data structure, myImage for storing the area data. imageId is a variable for storing an image ID. img is a variable for storing an image itself. X is a variable for storing an x coordinate of the image while Y is a variable for storing a y coordinate. W is a length of the image in the x direction while H is a length of the image in the y direction. “description” is a variable for storing a label for the image that is edited by the user. Next is a variable for storing the next image that is linked from the current image. Prev is a variable for storing a previous image that is linked to the current image. mRegion( ) is a variable for storing the area as a group element. mRegion_n is an index variable for mReion( ). line( ) is a variable for storing the line as a group element. line_no is an index variable for line( ). mImg( ) is a variable for storing the image as a group element. nimg( ) is an index variable for mImg( ). In the following description, certain expressions are abbreviated as shown in the example below. For, qtm_n in the third area of mRegion( ) in the second image of mImg( ) is expressed as “mImg(2), mRegion(3)·qtm_n.” Alternatively, the head portion is abbreviated as “mRegion(3)·qtm_n” for the same example. The input image is inputted to the computer 101 through the video interface 211 as shown in FIG. 2, and the inputted image is sequentially arranged in the mImg( ). For example, the input image 401 is stored in mImg(0)·img.

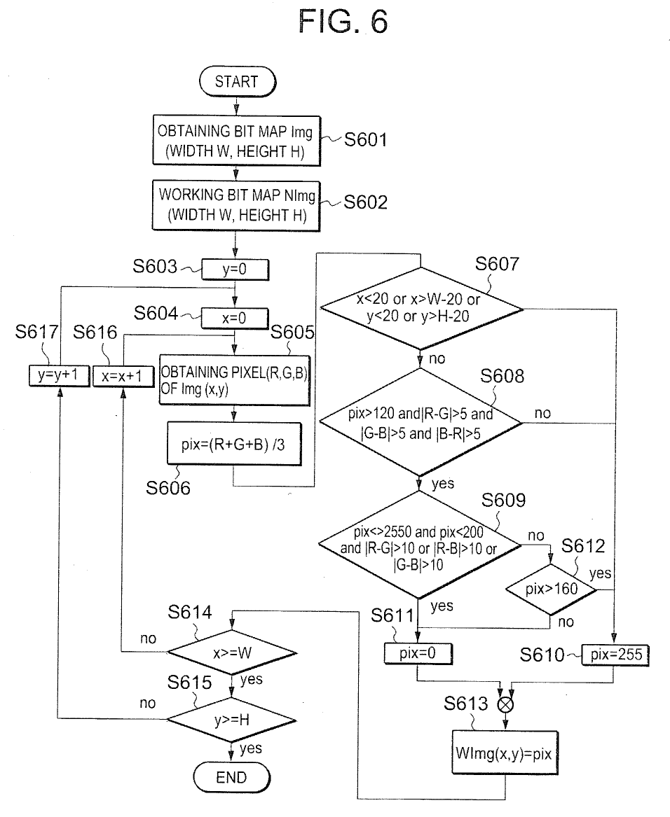

Now referring to FIG. 6, a flow chart illustrates steps involved in one preferred process of information processing by the noise removing unit 301 according to the current invention. Some of the information process is performed by the image processing unit 201 and the automatic area labeling unit 202. Others are performed by the noise removing unit 301 and the binarizing unit 302. In a step 601, a bit map 1 mg of the size of W×H is obtained as an input image 401. In a step 602, a working bit map image WImg is generated. In a steps 603 and 604, a value of “0” is respectively inserted in the variables x and y. Subsequently, a pixel RGB value is obtained at the x and y positions of the 1 mg in a step S605, and an average value is determined for the RGB values in a step S606. The average pixel value is then stored in “pix” in a step S606. In a step 607, it is determined whether or not a surrounding area of the image 401 is noise to be removed. As shown in FIG. 4, the image portion 415 is removed as a noise portion. To determine the noise, if x<20, x<W−20, y<20 or y<H−20, then it is determined as a noise portion. If a pixel at (x, y) is determined to be a near portion based upon the above criteria, the variable, “pix” at the (x, y) now is inserted a value of 255 to indicate white in a step S610. In effect, the pixel at (x, y) has been removed. On the other hand, if a pixel at (x, y) is not determined to be a near portion based upon the above criteria in the step S607, the pixel at (x, y) is further processed in a step S608. In the step S608, it is determined whether the pixel is a noise to be removed for its grayness and or the small difference in RGB values with a high intensity value. The above step thus removes the reflective light portion 414 as shown in FIG. 4. For the pixel (x, y) that is determined to be a part of a gray portion in the step S608, a value of 255 is inserted in the pix to indicate white in a step S610. The determination is made based upon the following equations: pix>120 and |R−G|>5 and |G−B|>5 and |B−R|>5. If it is determined in the step S608 that the pixel (x, y) is not a part of the near portion, the pixel (x, y) is further processed in a step S609.

Still referring to FIG. 6, in the step S609, if the pixel (x, y) has a predetermined sufficient difference among the RGB values, a determination is made on the pixel (x, y) to allocate a black pixel in the binarization of a portion of a drawing object. The determination is made based upon the following equations: pix<>255 and pix<200 and |R−G|>10 or |R−B|>10 or |G−B|>10. For the pixel (x, y) that has been determined to have the sufficient RGB value difference in the step S609, a value of 0 is placed in the corresponding pix to indicate a black pixel in a step S611. For the pixel (x, y) that has been determined not to have the sufficient RGB value difference in the step S609, it is further determined in a step S612 whether pix is larger than 160. If pix is larger than 160 to indicate sufficient whiteness in the step S612, a value of 255 is placed in the corresponding pix to indicate a white pixel in a step S610. On the other hand, if pix is not larger than 160 to indicate sufficient whiteness in the step S612, a value of 0 is placed in the corresponding pix to indicate a black pixel in the step S611. Subsequently, in a step S613, the above obtained value in pix is placed at the x, y position in the working image WImg as shown in the equation, WImg (x, y)=pix. In steps S614 through 617, x and y are respectively compared to W and H in the steps S614 and S615 while x and y are respectively incremented by one in the steps S616 and S617. The above described steps are repeated until the variable x and y values both respectively exceed W and Y. The above described steps remove noise from the input image 401 and binarize the noise-free image 402 to obtain the binarized image 403 in the working image WImg.

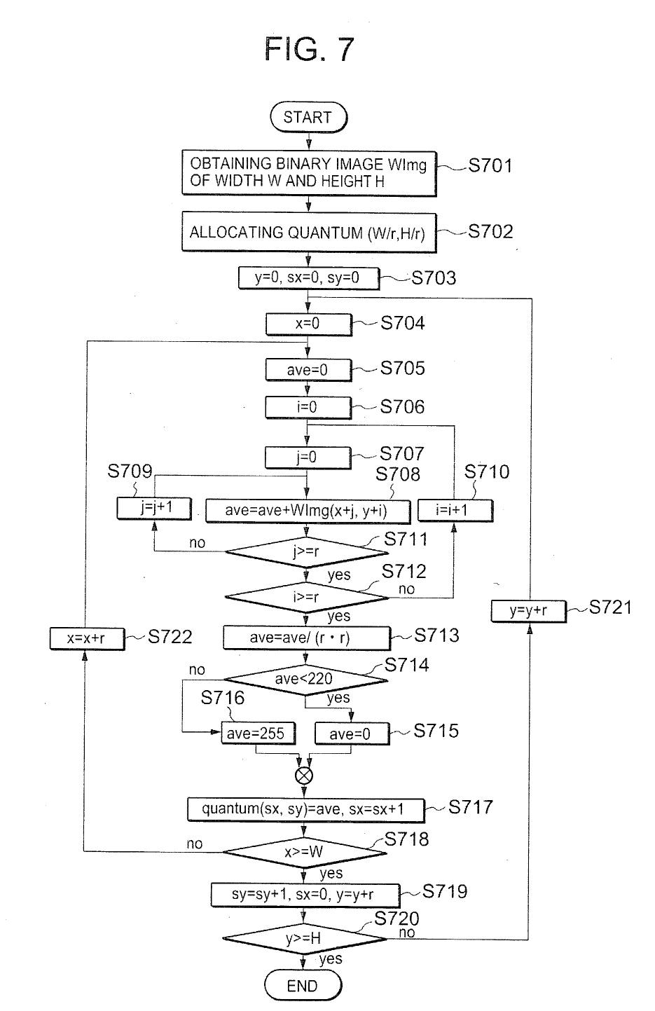

Now referring to FIG. 7, a flow chart illustrates steps involved in one preferred process of information processing by the quantizing unit 303 according to the current invention. In a step S701, the working image Wing is obtained in the width W and the height H as the binary image 403. In a step S702, a working array, quantum is allocated in the size of (W/r)×(H/r), where r is a resolution degree. For example, if r=8 and the Wing size is 640×480, the quantum size is 80×60. Subsequently, in steps 703 and 704, the variables x, y, sx and sy are each initialized to zero. In steps 705 through 717, the working imge WImg is divided into r×r tiles, and an average pixel value is determined for each of the r×r tiles. To do that, in the steps 705 through 707, the variables ave, i and j are each initialized to zero. The steps 708 through 713 determine the average value of each of the tiles and assign the average value to the variable ave. In details, the value of each pixel in a particular tile is summed in the step S708, and the summation is repeated for each of the pixels as specified by the steps S709 through S712. When the summation of the pixel values is complete, the average pixel value for the tile is determined in the step S713. If the average pixel value is determined in a step S714 to be smaller than a predetermined value such as 220, the variable ave value is replaced by 0 indicative of black in a step S715. On the other hand, if the average pixel value is determined in the step S714 to be not smaller than the predetermined value, the variable ave value is replaced by 255 indicative of white in a step S716. The above determined average pixel value for the title is then stored in an element of the quantum working array at sx, sy in a step S717. The sx position is also incremented by one in the step S717. The steps S705 through S717 are repeated until the variable x value reaches the width W as indicated in steps S718 and S722. When it reaches the predetermined value W, the variable sy value is incremented by one while the variable sx value is initialized to zero in a step S719. To start a next tile, the x value is incremented by r in the step S722 while the y value is also incremented by r in the steps S719 and S721. When the y value exceeds the predetermined H value in the step 720, the preferred process terminates. In the above described steps, the binarized image 403 is quantized, and the quantized image 404 is obtained in the working array quantum.

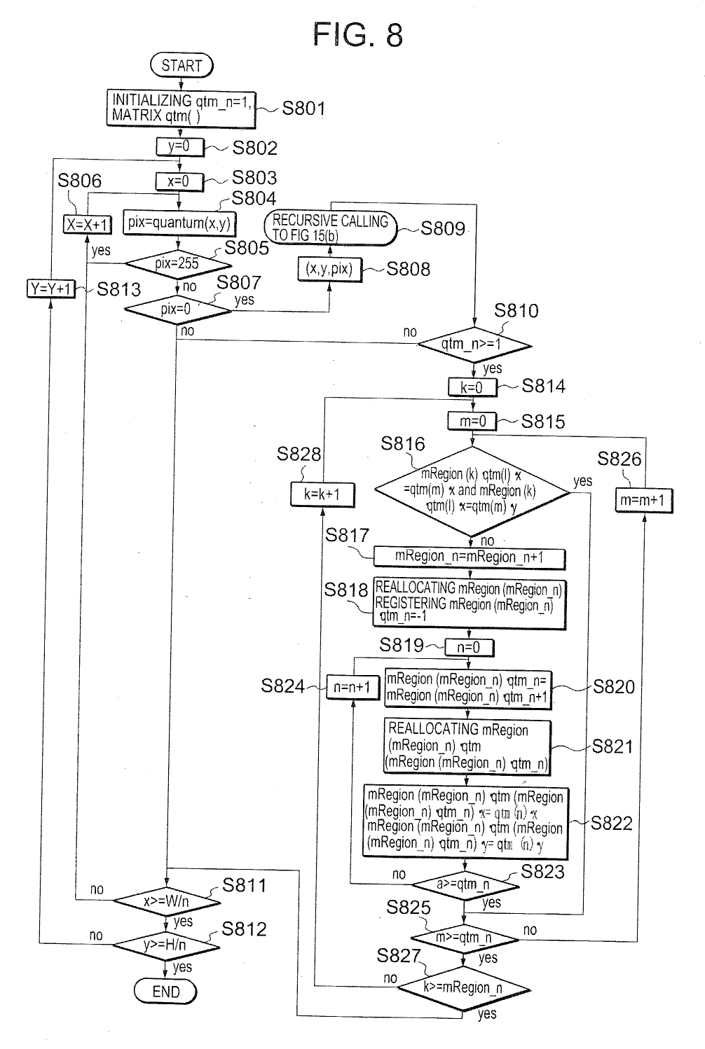

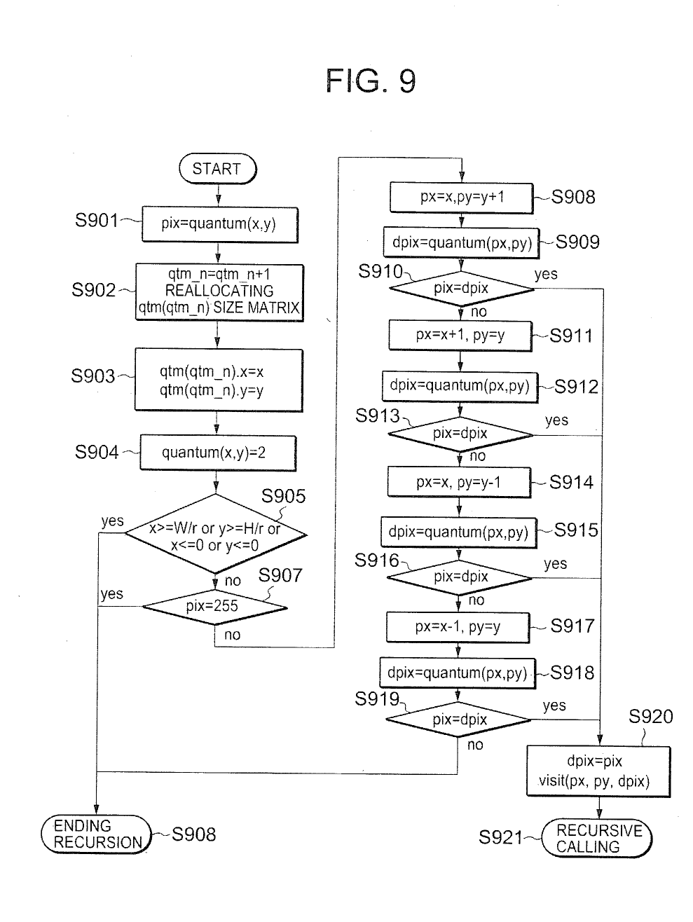

Now referring to FIG. 8, a flow chart illustrates steps involved in one preferred process of information processing by the automatic labeling unit 202 according to the current invention. In a step S801, a working array qtm( ) and its index variable qtm_n are initialized. Subsequently, in steps S802 and 803, working variable x and y are both initialized to zero. In a step S804, the value of quantum (x, y) as described with respect to FIG. 7 is now placed in a variable, pix. A step S805 determines whether the value in pix is equal to the predetermined value of 255, indicative of white. If it is determined in the step S805 that the variable pix value is equal to 255, the variable x is incremented by one in a step S806 and the step S805 is repeated. On the other hand, if it is determined in the step S805 that the variable pix value is not equal to 255, it is further determined whether or no the variable pix is equal to zero indicative of black in a step S807. If it is determined in the step S807 that the variable pix contains a value equal to zero or black, variables x, y and pix are used as parameters for a function visit( ) in a step S808. The visit( ) function is recursive and determines a pix value in the quantum array (x, y) that touches x=0. A step S809 is a recursive call in the visit( ) function, which will be further described with respect to FIG. 9.

After the recursive process is completed, the preferred process returns back to the step S809. Following the recursion, it is determined in a step S810 whether or not the quantum index variable qtm-n is equal to or larger than 1. That is, if a black area continuously exists in the periphery of quantum (x, y), and the quantum index variable, qtm-n is equal to or larger than 1, the preferred process proceeds to a registering process of the area data starting at a step S814. On the other hand, the preferred process proceeds to steps S811 through 813 in other situations. In the area data storing process, when the currently detected qtm ( ) array is different from the position of the already stored area data, the current data is newly stored as area data. In contrast, when the current data has the same area data position as the already stored one, the current data is not registered. Still referring to FIG. 8, in a step S816, it is compared between the already registered (mRegion( )·qtm( )·x; mRegion ( )·y·qtm ( )·y), and the currently detected (qtm ( )·x; qtm ( )·y). If it is already registered, the preferred process proceeds to a step S825. If it is not registered, an index variable m Region _n of the array m Region ( ) is incremented by one in a step S817. In a step S818, mRegion (mRegion_n) is newly allocated. For example, a character string such as “R25” is placed in m Region (mRegion_n)·reg ID. The character string, “R25” has “R” in front of an index number. In steps S819 through S823, the position information on the area is detected by the array qtm ( ). The newly discovered information is sequentially placed in (mRegion ( )·qtm ( )·x; mRegion ( )·qtm ( )·y). In a step S825, the steps S816 through S824 are repeated for the detected qtm ( ). In a step S827, the steps S815 through S826 are repeated for all of the already registered area data. When the steps S815 through S826 are all completed for all of the already registered area data as confirmed by k>=mRegion_n, the preferred process proceeds to the steps S811 through S813, where the steps S803 through S828 are repeated for every quantum ( ).

Now referring to FIG. 9, a flow chart illustrates steps involved in a preferred process of recursion by the visit ( ) function according to the current invention. In a step S901, the value of quantum (x, y) at x, y is placed in a function variable, pix that is different from pix as shown in FIG. 8. In a step S902, qtm_n as generated in FIG. 8 is incremented by one for an array size to allocate again for the memory. In a step S903, elements x and y are respectively placed in qtm. In a step S904, the value 2 is placed in quantum (x, y). The value indicates that the position at quantum (x, y) has been processed by the visit( ) function. In a step S905, it is determined whether or not (x, y) has reached an end of up-down and right-left directions in the quantum array. If the end had been reached, the preferred process proceeds to a step S906 in order to finish the recursive process. If the end has not been reached, the preferred process proceeds to a step S907, where it is determined whether the pix value is 255 or white. If it is determined in the step S907 that pix=255, the preferred process proceeds to the step S906 to complete the recursive process. If pix is not 255, the preferred process proceeds to a step S908. In steps S909 through S919, a value is searched around quantum (x, y) in the up-down and right-left directions. If a pixel value dpix at a search position (px, py) is equal to the pixel value pix at (x, y); either one of px, py and dpix is used for the visit function as parameters in a step S920. In a step S921, the visit( ) function is recursively called. If the pixel value at a detection position in the up-down and right-left directions is different from that at (x, y), the preferred process proceeds to a step S906, where the recursion is completed.

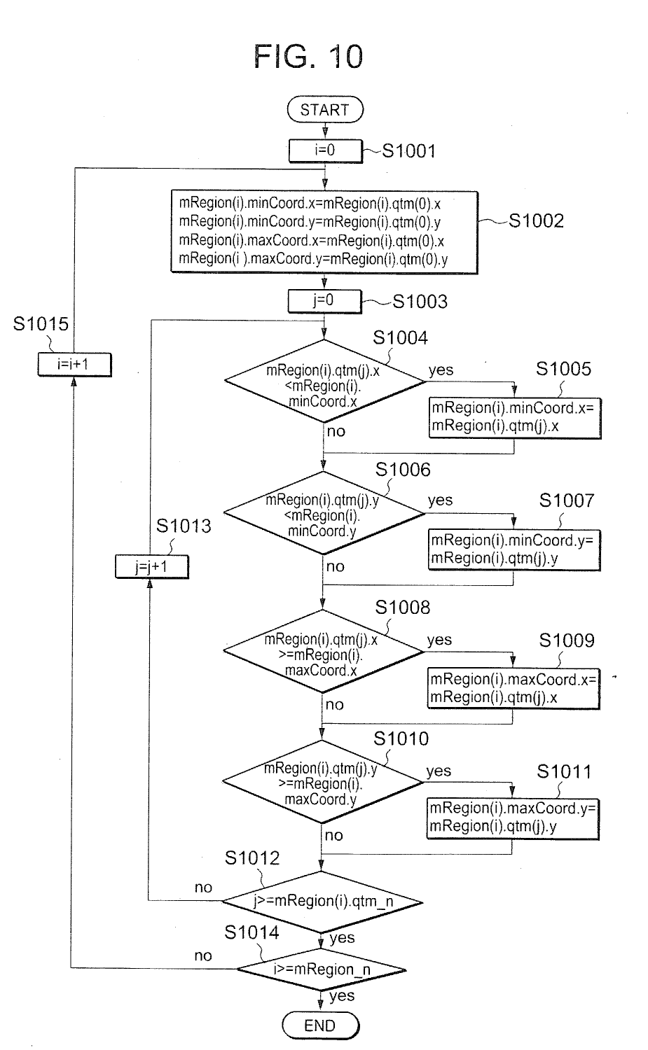

Now referring to FIG. 10, a flow chart illustrates steps involved in a preferred process of automatic labeling by the automatic area labeling unit 202 according to the current invention. Based upon the positional information on each area as determined in FIG. 8, an information process flow is illustrated to lead to the coordinates of the upper left and lower right corners of each area. In steps 1001 through 1015, a minimal value and a maximal value of the x and y coordinates are determined from the mRegion ( ) array positional information (mRegion(i)·qtm(j)·x; mRegion(i)·qtm(j)·y) as detected in FIG. 8. The upper left and lower right coordinates of each area from FIG. 8 are determined as x and y minimal coordinate values and x and y maximal values. The mRegion ( ) array from FIG. 8 or the area data of the input image 401 is registered in association with the input image 401 in the area registering unit 203.

(2) Information Process For Document Generation

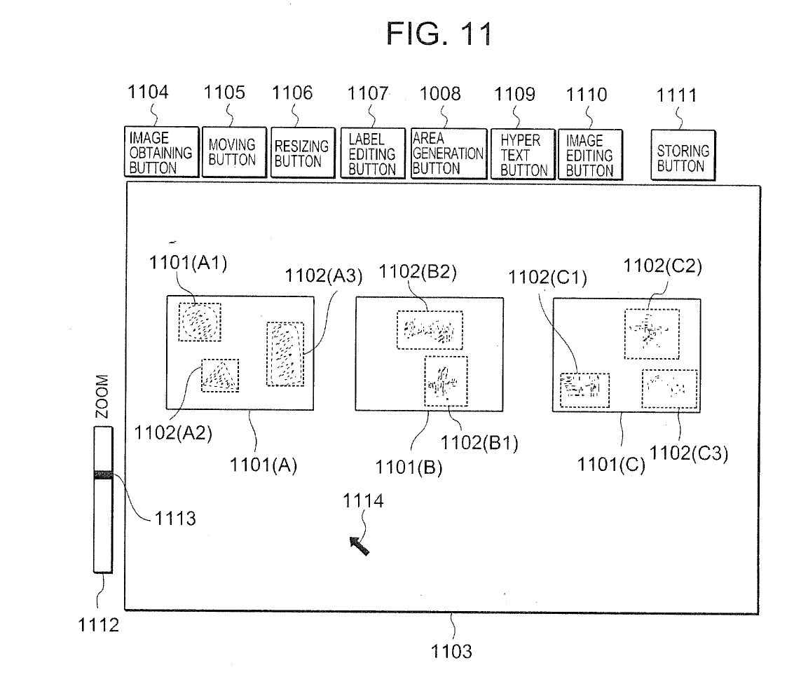

A preferred embodiment for information processing will be described with respect to the hypertext editing unit 206 and the hypertext registering unit 208. Now referring to FIG. 11, a diagram illustrates a graphical user interface (GUI) for the user to input data into the computer 101 in the preferred embodiment according to the current invention. The GUI is displayed as a bit-map image on the display unit 104 by the editor 204. The user inputs data by a device such as a keyboard 105 or a mouse 106 while the GUI from the editor 204 is being displayed on the display unit 104.

The GUI includes a window area 1103 to display image recognition information 1101 indicative of registered input image in the area registering unit 203 as well as area recognition information 1102 indicative of area data as also registered in the area registering unit 203. The GUI further includes various function buttons such as an image obtaining button 1104, a moving button 1105, a resize button 1106, a label editing button 1107, an area generation button 1108, a hypertext button 1109, a drawing edition button 1110 and a save button 1111. In addition, the GUI also includes zoom variable sliders 1112 and 1113 for modifying the display scale of the image recognition information 1101 and the area recognition information 1102 in the window 1103. As the user physically moves the mouse 106, the display position of a mouse cursor 1114 correspondingly moves in response to a relative positional change. For example, the display position of the mouse cursor 1114 is detected in the (x, y) coordinates. In the window area 1103, the information display in the editor 204 displays the image recognition information 1101 to indicate input images that are registered in the area registered unit 203.

In FIG. 11, image recognition information 1101 (A), 1101 (B) and 1101 (C) is displayed respectively indicating images A, B and C. The image recognition information 1101 does not have to be an input image itself or a copy at a reduced size. The image recognition information 1101 is alternatively displayed by a symbol such as a number that indicates an order of images. In the window area 1103, the information display in the editor 204 displays the image area recognition information 1102 for the area data that is registered in the area registering unit 203. In FIG. 11, the area recognition information 1102 (A1), 1102 (A2) and 1102(A3) is displayed respectively related to the areas A1, A2 and A3 for the input image A. Similarly, the area recognition information 1102 (B1), 1102 (B2) and 1102 (B3) is also displayed respectively related to the areas B1, B2 and B3 for the input image B. The area recognition information 1102 does not have to be a partial area of the input image itself or a copy at a reduced size. The area recognition information 1102 is alternatively displayed as a sub-area image itself that is separate from the input image or a copy at a reduced size. The area recognition information 1102 is also displayed by a certain symbol.

As the user clicks a button by moving the mouse 106 to place the mouse cursor 1114 in the button area and pressing a mouse button of the mouse 106, the corresponding function of the button is activated. One button is an image get button 1104. As the image get button 1104 is clicked, a command is issued from an image taking unit of the editor 204 to a CCD camera 103. The CCD camera 103 takes an image of the writing surface of the whiteboard 102, and the image is input into the computer 101 via the video interface 211. In the above described preferred embodiment, nimg=nimg+1, and the index variable is incremented, and mImg(nimg) is newly allocated. The obtained image is placed in the newly allocated memory. For example, the initial position of the image is mImg(nimg) x=0, mImg(nimg)·y=0, and it is displayed at the upper left corner. One example of img ID is a character string such as “125”, which consists of “I” in front of the index nimg. The image size is placed respectively in Img(nimg)·w and mImg(nimg) h as an initial value.

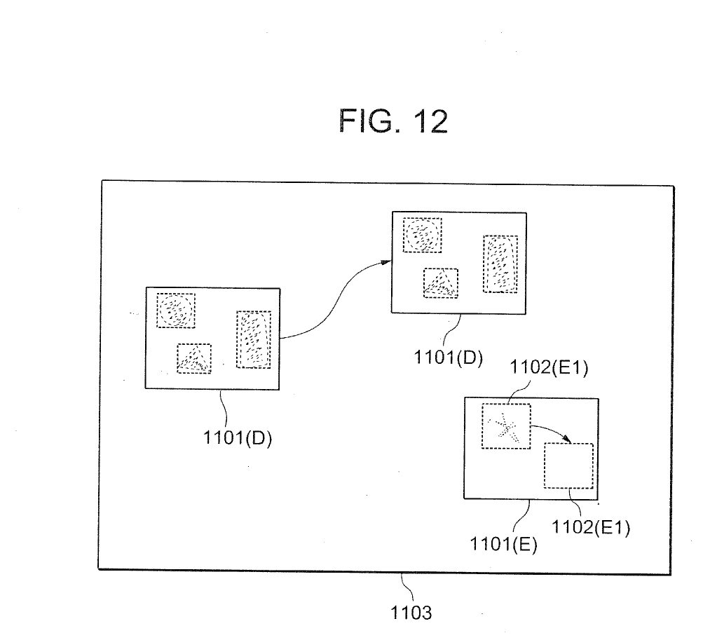

Upon clicking the move button 1105, the GUI changes to its move mode. In the move mode, the display position of the image recognition information 1101 and the area recognition information 1102 is changed in the window area 1103. FIG. 12 illustrates a process of moving a display position of the image recognition information 1101 (D) and the area recognition information 1102 (E). These display positions are moved by dragging and releasing of the mouse 106. To move the image recognition information 1101, the values (mImg(nimg) x; mImg(nimg) y) are replaced by the coordinates of the mouse cursor 1104 for the position renewal. To move the area recognition information 1102, the relative coordinate relation is determined between (mImg(nimg) x; mImg(nimg) y) and the mouse cursor 1114. The calculated values are placed in (mImg(nimg) mRegion(mRegion n) x; mImg(nimg) mRegion(mRegion n) y) to renew the position.

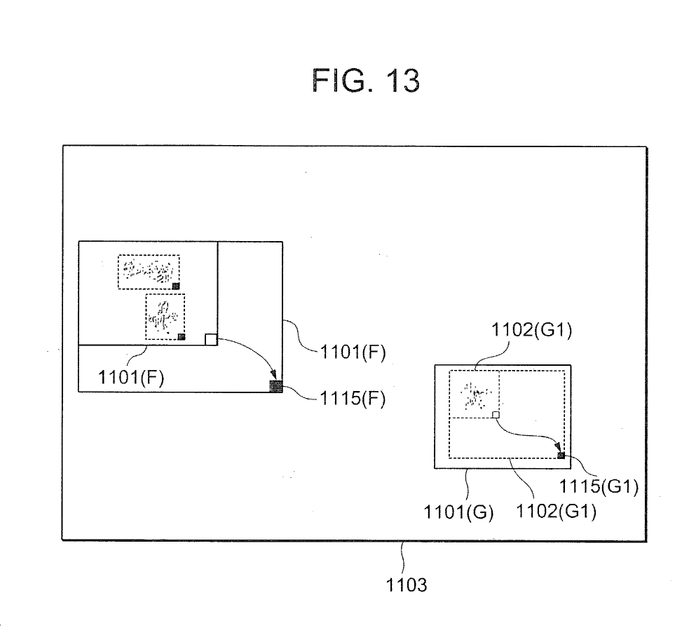

Upon clicking the resize button 1106, the GUI changes to its mode to the resize mode. In the resize mode, the area size as indicated in the window 1103 by the image recognition information 1101 and the area recognition information 1102 is changed by modifying the corresponding display size. FIG. 13 illustrates a process of changing the image recognition information 1101 (F) and the area recognition information 1102(G). In the resize mode, a resize object 1115 for resizing is displayed at a lower right corner of the image recognition information 1101 or the area recognition information 1102. The size of the image recognition information 1101 and the area recognition information 1102 is changed by dragging and releasing the mouse 106. To change the size of the image recognition information 1101, the values, (mImg(nimg)·w, mImg(nimg)·h) are revised. Similarly, to change the size of the area recognition information 1102, the values (mImg(nimg)·mRegion(mRegion_n)·w; mImg(nimg)·mRegion(mRegion_n)·h) are revised.

Upon clicking the label edit button 1107, the GUI is changed into the label edit mode. In the label edit mode, one preferred embodiment of the manual labeling unit 205 edits the label of the input image as indicated by the image recognition information 1101 and the label of the area as indicated by the area recognition information 1102 in the window area 1103. The above described mechanism allows the addition of the information such as memos for the areas and the input images.

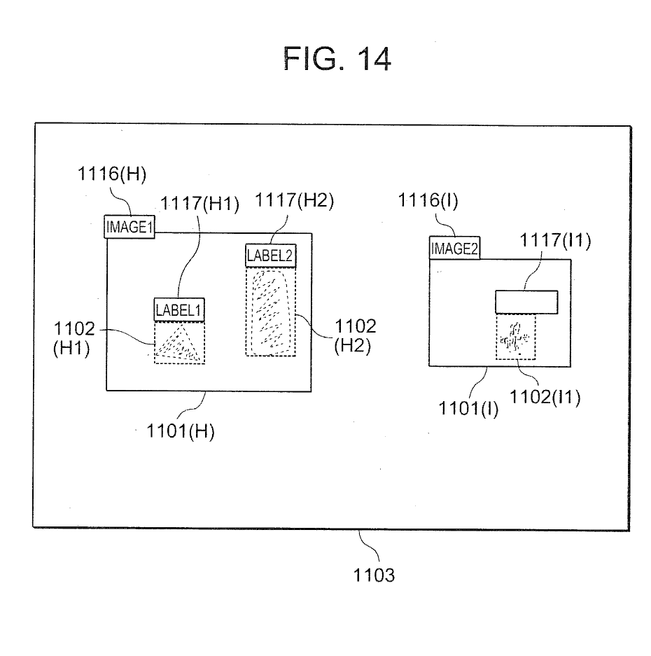

FIG. 14 illustrates a process of editing labels for the image recognition information 1101 (H) and 1101 (I) as well as the area recognition information 1102 (H1), 1102 (H2) and 1102(I1). Upon changing to the label edit mode, a label display object 1116 for editing a label for the image recognition information 1101 is displayed at the upper left corner. Similarly, a label display object 1117 for editing a label for the area recognition information 1102 is displayed at the upper left corner. These labels are enabled for editing by double clicking the label display objects 1116 and 1117 via the mouse 106. After being enabled, desired text is inputted for editing via the keyboard 105. The label enabled condition is terminated by clicking any portion outside the label areas. In editing the label for the input image as indicated by the image recognition information 1101, a character string mImg(nimg) mRegion(mRegion_n).description is revised.

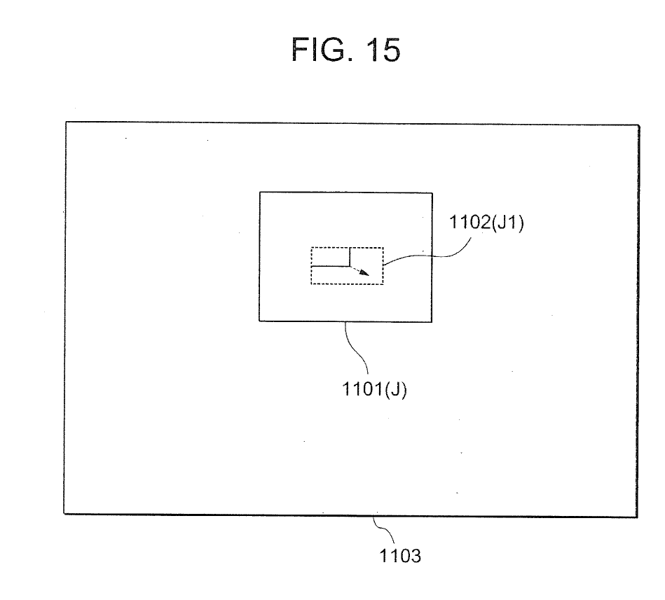

Upon clicking the area generation button 1108, the GUI changes its mode to the area generation mode. In the area generation mode, a new area is generated as a part of the input image as shown in the window 103. FIG. 15 illustrates a process where a new area is generated as a part of the input image by adding new area recognition information 1102 (J1) as a part of the image recognition information 1101 (J). The new area recognition information 1102 is added by dragging and releasing the mouse 106. To add new area recognition information 1102 as a part of the image recognition information 1101, an index variable is incremented as follows: mImg(nimg)·mRegion_n mImg(nimg)·mRegion_{—}+1, and mImg(nimg)·mRegion(mRegion_n) is further newly allocated. The coordinates are placed in (mImg(nimg) mRegion(mRegion_n)·x; mImg(nimg)·mRegion(mRegion_n)·y). The size is placed in (mImg(nimg)·mRegion(mRegion_n)·w; mImg(nimg)·mRegion(mRegion_n)·h).

Upon clicking the hypertext button 1109, the GUI changes its mode into a hypertext edit mode. In the hypertext edit mode, in response to the user input, the hypertext edition unit 206 of the preferred embodiment puts the area data as indicated by the area recognition information 1102 and the input image as indicated by the image recognition information 1101 in the window 103 into structures. That is, between the input images or between the areas, their relations are established by hypertext links. The user makes links between the input images as indicated by the image recognition information 1101 and between the areas as indicated by the area recognition information 1102 by looking at the window 1103.

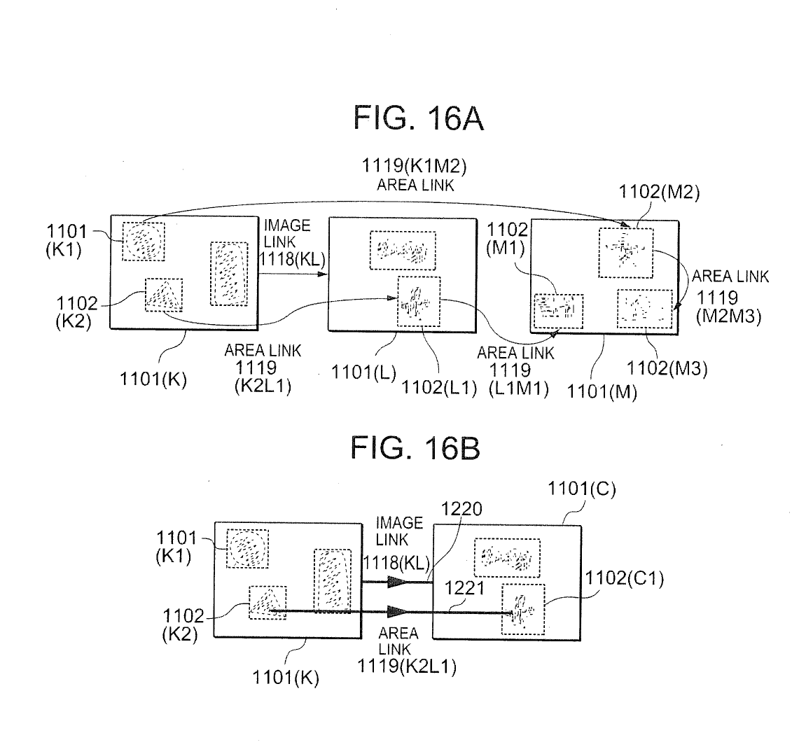

FIG. 16A illustrates a process of linking between the input images, between the areas of different input images and between the areas of the same input image. Concretely speaking, for example, an image link 1118(KL) is made between and input image as the image recognition information 1101 (K) and another input image as the image recognition information 1101 (L). Another example is that an area link 1119(K1M2) is made between an area as indicated by the area recognition information 1102 (K1) and another area as indicated by the area recognition information 1102(M2). Yet another example is that an area link 1119 (M2M3) is made between an area as indicated by the area recognition information 1102 (M2) and another area recognition information 1102 (M3). It is also an example to create area links 1119 (K2L1) and 1119(L1M1) that are connected. The above described links are created by dragging and releasing the mouse on the input images and the areas. To be precise, a link source is specified by a link specifying unit of the hypertext editing unit 206 upon dragging an input image via the mouse 106 as indicated by the image recognition information 1101 or an area as indicated by the area recognition information 1102. A link destination is specified by the link specifying unit of the hypertext editing unit 206 upon releasing the mouse 106 from an input image as indicated by the image recognition information 1102. In the above described manner, links such as an image link 1118 and an area link 1119 are generated from an image or an area as a link source to an image or an area as a link destination.

As shown in FIG. 16B, a display object 1220 for the image link 1118 and another display object 1121 for an area link 1119 are optionally displayed. When a link is to be made from the input image mImg(0) to the input image mImg(1), the mouse cursor 1114 is moved to an area within (mImge(0)·x; mImge(0)·y)˜(mImge(0)·x+mImge(0) w; mImge(0) y+mImge(0)·h). While the mouse is clicked in the area, the mouse cursor 1114 is being dragged to an area (mImge(1)·x; mImge(1)·y)˜(mImge(1)·x+mImge(1) w; mImge(1)·y+mImge(1)·h) and is released. In this case, (mImge(0) Next=“I1” and (mImge(0)·Prev=“I0” are inserted in as Img( ). imgID. The former means that mImg(0) indicates a first image with mImg(1) as a second image. The latter means that mImg(1) indicates a second image with mImg(0) as a first image. By this, referring to mImge(0) Next, mImg(0) is linked to mImg(1).

To display object for an image link to the image recognition information for the input image mImage(1) from the image recognition information for input image mImage(0), the following values are calculated. The coordinates G0 for the center of the gravity of the area, (mImg(0).x; mImg(0).y)˜(mImg(0).x+mImg (0).w; mImg(0).y+mImg (0).h) is as follows: (mImg(0).x+mImg (0).w/2; mImg(0).y+mImg (0).h/2). The coordinates G1 for the center of the gravity of the area, (mImge(1)·x; mImge(1)·y) mImg(1).x+mImg (1).w; mImg(1).y+mImg (1).h) is as follows: mImg(1).x+mImg (1).w/2; mImg(1).y+mImg (1).h/2). Subsequently, a certain line is displayed between the centers of the gravity G0 and G1. For example, a certain condition for the line is that the line has a color as specified by a 8-bit RGB value of (255, 0, 0). Furthermore, an arrow is optionally displayed at a middle point between the centers of the gravity G0 and G1. For an overlapping portion in the image recognition information between the input image mImg(0) to the input image mImg(1), the window area 1103 optionally hides the over lapping portion. This can be implemented by displaying the background color of the areas, (mImg(0).x; mImg(0).y)˜(mImg(0).x+mImg (0).w; mImg(0).y+mImg (O).h) and (mImg(1).x+mImg (1).w/2; mImg(1).y+mImg (1).h/2) by a 8-bit RGB color such as (255, 255, 255).

When a link is to be made from the area mImg(0).mRegion(0) for the input image mImg(0) to the area mImg(1).mRegion(1) for the input image mImg(1), the mouse cursor 1114 is moved to an area within (mImg(0).mRegion(0).x; mImg(0).mRegion(0.y) ˜(mImg(0).mRegion(0).x+mImg(0).mRegion(0).w; mImg(0).mRegion(0).y+mImg(0).mRegion(0).h). While the mouse is clicked in the area, the mouse cursor 1114 is being dragged to an area (mImg(1).mRegion(2).x; mImg(1).mRegion(2).y)˜(mImg(1).mRegion(2).x+mImg(1).mRegion(2).w; mImg(1).mRegion(2).y+mImg(1).mRegion(2).h) and is released. In this case, mImage(0).mRegion(0).Next=“I1R2” and mImage(0).mRegion(0).Prev=“I0R0” are inserted in as 1 mg( ).mRegion.imgID. The former means that mImg(0).mReion(0) indicates a first image with mImg(1).mReion(2) as a second image. The latter means that mImg(1).mReion(2) indicates a second image with mImg(0).mReion(0) as a first image. By this, referring to mImge(0).mReion(0) .Next, mImg(0) is linked to mImg(1).mRegion (2).

To display object for an area link to the area recognition information for the area mImg(1).mReion(2) for the input image mImg(1) from the area recognition information the area mImg(0).mRegion(0) for input image (0), the following values are calculated. The coordinates MG0 for the center of the gravity of the area, (mImg(0).mRegion(0).x; mImg(0). mRegion(0).y)˜(mImg(0).mRegion(0).x+mImg(0).mRegion(0).w; mImg(0).mRegion(0).y+mImg(0).mRegion(0).h) is as follows: (mImg(0).mRegion(0).x+mImg(0).mRegion(0).w/2; mImg(0).mRegion(0).y+mImg(0).mRegion(0).h/2). The coordinates MG1 for the center of the gravity of the area, (mImg(1).mRegion(2).x; mImg(1). mRegion(2).y)˜(mImg(1).mRegion(2).x+mImg(1).mRegion(2).w; mImg(1).mRegion(2).y+mImg(1).mRegion(2).h) is as follows: (mImg(1).mRegion(2).x+mImg(1).mRegion(2).w/2; mImg(1).mRegion(2).y+mImg(1).mRegion(2).h/2). Subsequently, a certain line is displayed between the centers of the gravity MG0 and MG1. For example, a certain condition for the line is that the line has a color as specified by a 8 bit RGB value of (255, 0, 0). Furthermore, an arrow is optionally displayed at a middle point between the centers of the gravity MG0 and MG1.

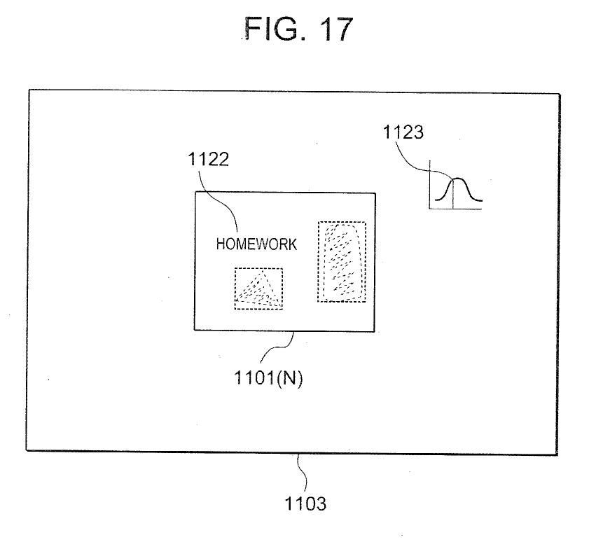

Upon clicking the drawing edit button 1110, the GUI changes its mode to the drawing edit mode. In the drawing edit mode, in response to the user input, the drawing edit unit 207 of the preferred embodiment adds a new drawing to the input image. FIG. 17 illustrates one example of adding a character string 1122 to the input image of the image recognition information 1101 (N) after the user draws “HOMEWORK.” As also shown, the user optionally draws a diagram or characters in the window area 1103. In order to add a new drawing to the input image Img(0), the mouse cursor 1114 is moved to an area within (mImg(0).x; mImg(0).y)˜(mImg(0)x+mImg(0).w; mImg(0).y+mImg(0) .h). At this time, mImg(0).line_n is made to be mImg(0).line_n+1 so that the structural index variable to the drawing array is incremented. The mImg(0).line(line_n) array is reallocated. Subsequently, as the mouse cursor 1114 moves, mImg(0).line(line_n).n receives mImg(0).line(line_n).n+1, and each structural index variable to the line array is incremented. Furthermore, the coordinates of the mouse cursor 1114 are placed in (mImg(0).line(line_n).mpoints(mImg(0).line(line n).n).x; mImg(0).line(line n).mpoints(mImg(0).line(line n).n).y). The above process is repeated until the mouse 106 is released. By displaying the above stored coordinate array as a line in the window area 1103, the user is able to draw arbitrary characters and diagrams.

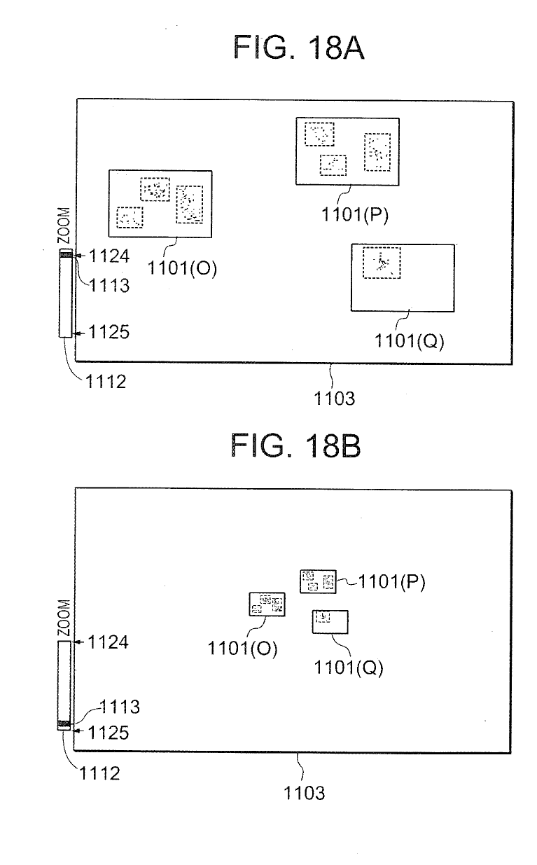

Now referring to FIGS. 18A and 18B, diagrams illustrate the zoom sliders 1112 and 1113 along with other display objects. The variable zoom slider 1112 is a scroll bar while the variable zoom slider 1113 is a scroll box that moves up and down in the scroll bar 1112. The mouse cursor 1114 is moved over the scroll box 1113 and is dragged upwardly and downwardly over the scroll bar 1112 while the mouse cursor 1114 is held clicked. The scroll box 1113 also follows the movement. As shown in FIG. 18A, when the scroll box 1113 is positioned at an upper end 1124 of the scroll bar 1112, the display scale for the image recognition information 1101 and the area recognition information 1102 has the maximal value for the window area 1103. On the other hand, as shown in FIG. 18B, when the scroll box 1113 is positioned at an lower end 1125 of the scroll bar 1112, the display scale for the image recognition information 1101 and the area recognition information 1102 has the minimal value for the window area 1103. By the display scale, the user is able to enlarge a particular one of the image recognition information 1101 or to reduce the size to display all of the image recognition information 1101.

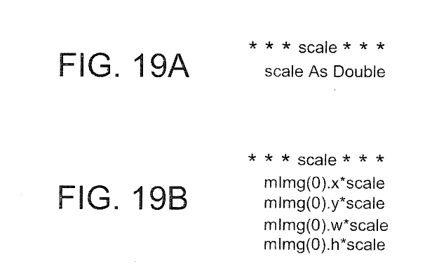

FIGS. 19A illustrates a structure that defines a variable, scale in a double precision floating point (Double). As the scroll box 1113 moves, the corresponding value is placed in the variable, “scale.” For example, scale=1.0 when the display scale value is the maximal, while scale=0.1 when the display scale value is the minimal. According to the display scale, the variable value changes between the above two values.

FIG. 19B illustrates an exemplary structure for the input image, mImg(0) in which the position of the input image is multiplied by the scale variable, “scale” for displaying in the window area 1103. The input image, mImg(0) is displayed at a size that is proportional to the scale value. The above described process is performed on the whole array of mImg( ), whole regions of mImg(o as well as whole lines, line( ).

Upon clicking the save button 1111, the input image as indicated by the image recognition information 1101 and the area as indicated by the area recognition information 1102 in the window area 1103 are transferred to the hypertext registration unit 208. By the hypertext registration unit 208, the above data is converted into the HTML format that is viewable by the Web browser 108. The converted data is stored in the hard disk 209 in the clickable map format, which enables a link from a portion of the image on the HTML document displayed on the browser to a portion of another image. The clickable format is defined by “W3C, HTML 4.01 Specification, [on-line] http://www.w3.org/TR/1999/REC-html401-199991224/” and is a prior art technology.

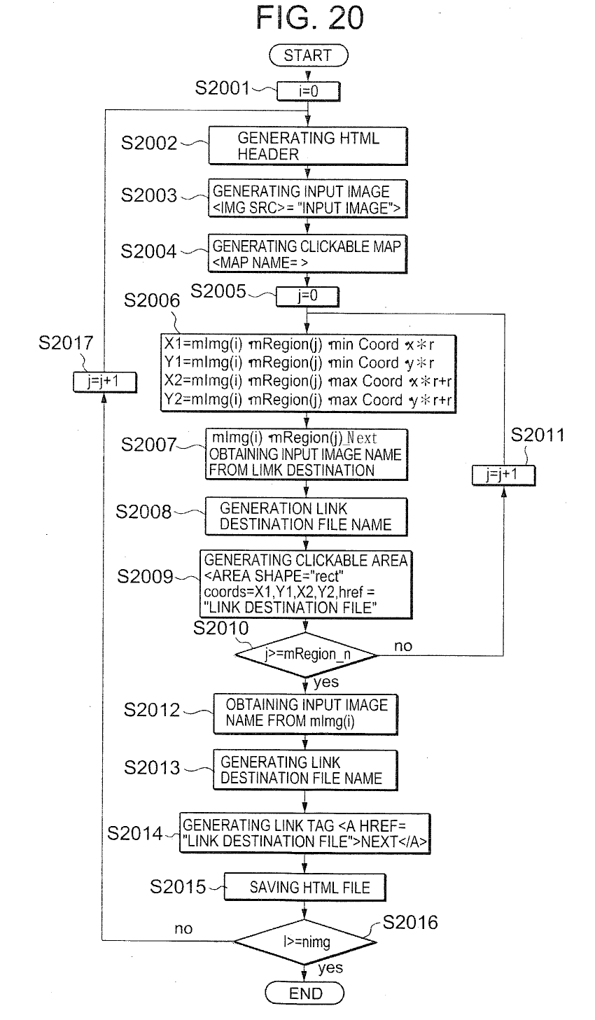

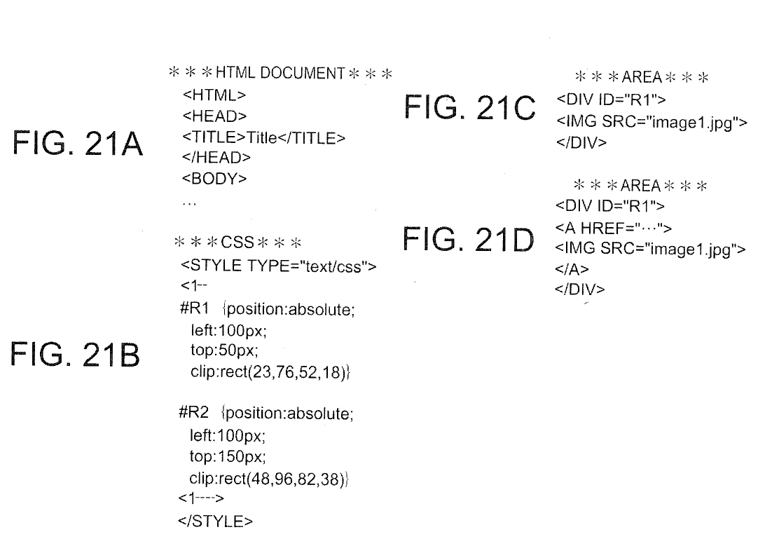

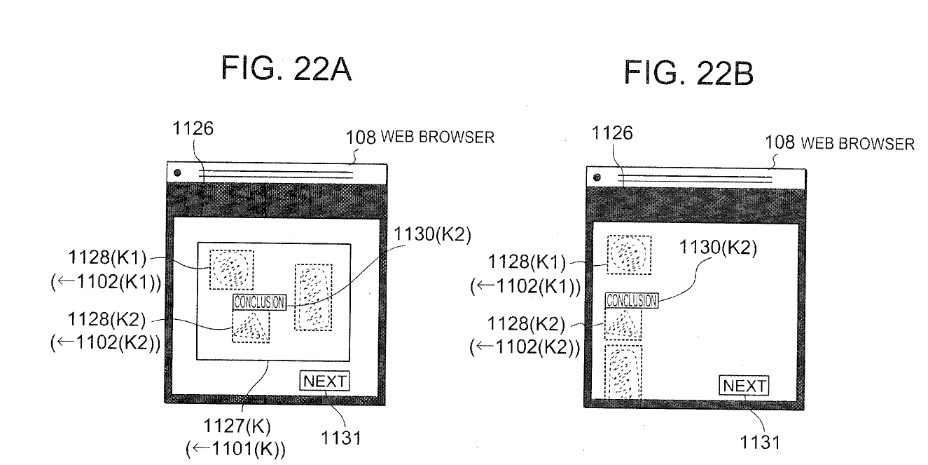

Referring to FIG. 20, a flow chart illustrates steps involved in a preferred process of converting the document data into the HTML format according to the current invention. The input image is contained in the document data, and the images in the areas that are in the document as a part of the input image are herein after called the area images and are stored as clickable maps. The details will be later described with respect to FIG. 22A. By the above conversion, the input image and the area images are viewable by widely used Web browsers 108. In a step S2001, the variable i is initialized, and in a step S2002, a HTML header is generated. The HTML header contains information to indicate that the current document is a HTML document as shown in FIG. 21A. In a step S2003, by using <IMG SRG=” “>tag, a HTML tag is generated so that each input image is displayed as an image on the Web browser 108. In a step S2004, another tag <Map NAME=. . . > is generated for defining the clickable map. In a step S2005, the variable j is initialized to zero. In a step S2006, by referring each area data, the coordinates of the upper left corner and the lower right corner are obtained. By enlarging the size by the resolution r, X1, Y1, X2 and Y2 are respectively determined according to the scale of the original input image. In a step S2007, by referencing each area data, the input image name is obtained for the link destination of each area. In a step S2008, a file name is generated for the document contained in the current input image. Exemplary rules for the file name generation include the addition of a file extension “.html” to a character string, “125” such as defined by “mImg(i).imgID.” In a step S2009, using the tag <AREA SHAPE . . . >, a HTML tag is generated for making each area image a clickable map. As shown in the steps S2005 through 2011, the steps S2009 through S2009 are performed on all ranges of the data. Subsequently, In a step S2012, by referring to each input image, the input image name is obtained from the link destination of the input image. In a step S2013, a file name for the document containing the current input image is generated. The file name generation rules are the same as those of the steps 2007 and 2008. In a step S2014, using the tag <A HREF=. . . >, a link is generated to the file name that has been generated in the step S2013. In a step S52015, the above generated HTML tags are stored in the hard disk 209 as a file related HTML format document. As shown in the steps S2001 through S2017, the steps S2002 through 2015 are performed on all of the input images 203.

Now referring to FIG. 22A, a diagram illustrates that the hypertext registering unit 208 displays the HTML formatted document 1126 stored in the hard disk 209 on the Web browser 108. The Web browsers 108 include Internet Explorer® from Microsoft Corporation and Netscape Navigator® from Netscape Corporation. When a link is generated as shown in FIG. 16A, an initial screen of the Web browser 108 displays an input image 1127(K) as indicated by the image recognition information 1101(K) as a link source in the link structure as illustrated in FIG. 22A. The area image 1128(K1) as indicated by the area recognition information 1102(K1) is displayed as a part of the input image 1127(K). As shown in FIG. 22A, the area labels related to the image area 1128 in the input image 1127 are displayed as text as shown in a label 1130(K2). Upon clicking the area image 1128(K2), since the area image 1128(K2) as indicated by the area recognition information 1102(K2) is linked to the area image 1128(L1) as indicated by the area recognition information 1102(Li) by the clickable map <AREA SHAPE . . . > as shown in FIG. 16A, the input image 1127(L) of the image recognition information 1101(L) is automatically displayed in the Web browser 108.

Further more, when the input image 1127(K) of the image recognition information 1101(K) is linked to the input image 1127(L) of the image recognition information 1101(L) as shown in FIG. 16A, the input image 1127(K) is displayed in the Web browser 108 as shown in FIG. 22A. Under the above circumstances, the link buttons 1131 such as “Next” are displayed in the Web browser 108. Upon clicking the link button 1131, the tag <A HREF=“ ”> is interpreted, and the input image 1127(L) of the image recognition information 1101(L) is automatically displayed in the Web browser 108.

Since the browser 108, HTML and HTTP (Hypertext Transfer Protocol) for converting the HTML document on the network are known to one of ordinary skill in the relevant art, their detailed description will not be provided. The HTTP is a communication protocol for transmitting and receiving with the display format multi-media files including the text, image and voice written in HTML. For example, the protocol is defined at http://www.w3.org/Protocols/ As one example of the conversion to the HTML formatted document as shown in the flow chart of FIG. 20, one HTML document is generated for each input image and is included in the input image. As a part of the input image, an area image is contained in the document. The above two inclusions, the conversions are described with respect to FIG. 22A. In the following, another example of the conversion to the HTML formatted document will be later explained with respect to FIG. 22B, where one HTML formatted documents is generated for one input image and the conversion is made to include in the document an area image that is cut out from the input image.

In order to include in the document the cut out area image from the input image, a language called cascading style sheet (CSS) is utilized. Since the CSS is known to one of ordinary skill in the art and is described at http://www.w3.org/TR/REC-CSS2/, the detailed description will not be repeated here. The CSS is a language that separate the style specification from the HTML that describe the logical structure of a Web documents. In stead of HTML, another language such as the CSS is used to describe characteristics the objects such as images and text on the Web browser. The characteristics include the visual characteristics and the layout characteristics. More concretely, as shown in FIG. 21B, the CSS description is added to each area of the HTML document. For a portion such as “R1” or “R2,” the area ID or mRegion( ).regID is displayed. Position:absolute means that an object is displayed at an absolute position in the Web browser. Left:100px means a distance of 100 pixels from the left end to display an object in the Web browser. Top:50px means a distance of 50 pixels from the top end to display an object in the Web browser. When a plurality of areas is used, for example, the “top” value for the first area is “50px.” For each of other areas, the width in the Y direction as indicated by “mRegion( ).h” of a previous area is added to the “top” value of the previous area so that each area is vertically arranged according to the area order for displaying in the Web browser. clip:rect( ) is a notation for specifying the coordinates for the upper left corner and the lower right corner of a rectangle to be displayed on the Web browser. The exact specification is “clip:rect(top, right, bottom, left) for the upper left corner coordinates and the lower right corner coordinates. To specify each area for displaying on the Web browser, the upper left corner coordinates are replaced by (mRegion( ).x, mRegion( ).y). Similarly, the lower right corner coordinates are replaced by (mRegion( ).x+mRegion( ).w, mRegion( ).y+mRegion( ).h).

After each area has been specified by CSS, partial HTML language is provided for displaying the preferred embodiment on the Web browser. Since the use of the HTML language is known to one of ordinary skill in the art, the details are not described. Initially, a character string that contains the area ID, mRegion( ).regID is inserted into the ID that is specified by DIV as shown in FIG. 21. For example, if the ID is “R1,”<DIV ID=” R1”>. Using <IMG SRC=tag, a HTML tag is generated from each input image as an image for the Web browser to output. For example, if an input image has a file name such as “image1.jpeg,” it is noted as in <IMG SRC=“image1.jpg”>. The above notation is made for each area.

To generate a link, as described with respect to FIG. 20, the tag, <A HREF=. . .> is used. In this case, the notation method is like FIG. 21D. FIG. 22B illustrates the viewing of the HTML document 1126 as generated and then saved in the above described manner. In case of FIG. 22B, a link button 1131 such as “NEXT” is also displayed as in FIG. 22A. The display method of each area image 1128 is not limited to the vertical arrangement as shown in FIG. 22B. For example, the display is also made in a horizontal arrangement or a table arrangement. For the document 1126 having each area image 1128, the document 1126 is generated to have each area image as a part of the input image 1127 as shown in FIG. 22A. Alternatively, the document 1126 is generated to have each area image 1128 that has been cut out from the input image 1127 as shown in FIG. 22B. It is another option to generate the document 1126 that concurrently contains the input image 1127 and each area image 1128 cut from the input image 1127. Lastly, the document 1126 is generated to be interchangeable between FIGS. 22A and 22B.

(3) Preferred Embodiments and Other Examples

As one example of one preferred embodiment according to the current invention, the computer 101 has been explained. Other examples include devices with the computer 101 and one or all of a whiteboard 102, a CCD camera 103, a display 104, a keyboard 105 and a mouse 106. The above devices will be hereafter called a multi-functional machine 2301. One example of the multi-functional machine 2301 is a digital camera that includes a CCD camera 103 embodying the computer 101. Another example of the multi-functional machine 2301 is a personal computer that includes the computer 101, the display 104, the keyboard 105 and the mouse 106. Yet another example of the multi-functional machine 2301 is an electronic whiteboard that includes the computer 101 and an internal CCD camera 103.

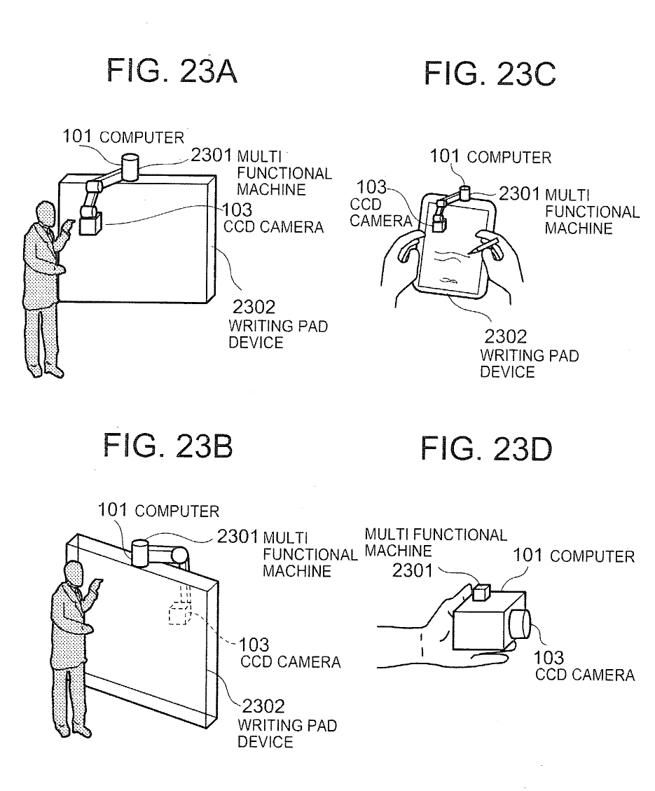

Now referring to FIGS. 23A through 23D, diagrams illustrate preferred embodiments of the multi-functional machine 2301 according to the current invention. In particular, FIG. 23A illustrates one preferred embodiment of the multi-functional machine 2301 including a writing pad device 2302 that is equipped with the computer 101 and the CCD camera 103. FIG. 23B illustrates a second preferred embodiment of the multi-functional machine 2301 including the writing pad device 2302 that is equipped with the computer 101 and the CCD camera 103. Since the writing pad device is transparent material such as glass, the CCD camera 103 captures the image on the surface of the writing pad device 2302 from the reverse side. FIG. 23C illustrates a third preferred embodiment of the multi-functional machine 2301 including the writing pad device 2302 that is equipped with the computer 101 and the CCD camera 103. Since the writing pad device 2302 is compact, the multi-functional machine 2301 is a portable device. FIG. 23D illustrates a fourth preferred embodiment of the multi-functional machine 2301 including the writing pad device 2302 that is equipped with the computer 101 and the CCD camera 103. Unlike the first, second and third preferred embodiments as shown in FIGS. 23A, 23B and 23C, the multi-functional machine 2301 has a separate body of the writing pad device 2302.

The whiteboard 102 has been used as a part of the preferred embodiment or as a peripheral to the preferred embodiment. In alternative embodiments, any other writing devices other than the whiteboard 102 are used so long as drawings are created. For example, other writing devices include a LCD panel with a touch panel for displaying information that has been inputted through the touch panel.

The CCD camera 103 has been used as a part of the preferred embodiment or as a peripheral to the preferred embodiment. In alternative embodiments, any other cameras other than the CCD camera 103 are used so long as images are captured from the writing surface of the writing pad device.

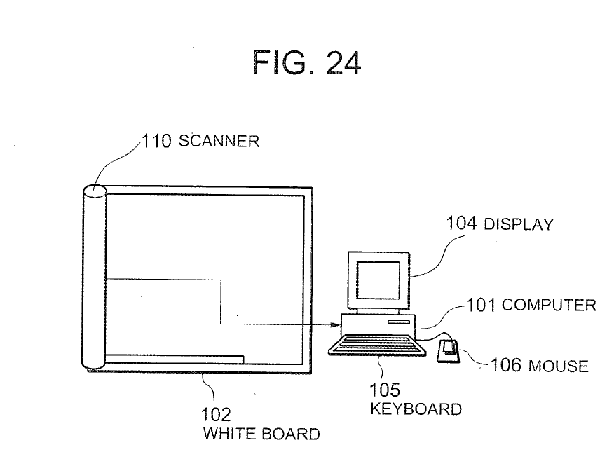

Furthermore, in lieu of the cameras, a scanner is optionally used to capture an image by scanning the surface where the images are created. Now referring to FIG. 24, a diagram illustrates an alternative embodiment of the system of FIG. 1, where the CCD camera 103 is replaced by the scanner 110 according to the current invention. That is, one preferred embodiment of the system further includes the computer 101, the whiteboard 102, the CCD camera 103, the display 104, the keyboard 105 and the mouse 106. The scanner 110 of the preferred embodiment is placed to scan the writing surface of the whiteboard 102. Upon clicking the image capturing button 1104, the scanning part of the editor unit 204 sends a corresponding command to the scanner 110, and the scanner 110 scans the writing surface of the whiteboard 102. The image that is scanned by the scanner 110 from the writing surface of the whiteboard 102 is inputted into the computer 101 via the video interface 211.

For the preferred embodiment according to the current invention, the HTML document was considered above. Any documents other than in the HTML format are alternatively used as long as the documents are capable of including images or partial images and the included images or the partial included images are also capable of linking to other images or other partial images. For example, other document formats include eXtensible MarkUp Language (XML).

The multi-functional machine 2301 of FIG. 23 and the computer 101 of FIGS. 1 and 24 are preferred embodiments of the information processing apparatus according to the current invention. Similarly, the information processing methods as performed by the multi-functional machine 2301 of FIG. 23 and the computer 101 of FIGS. 1 and 24 are preferred processes of the information processing according to the current invention. For example, the information processing methods according to the current invention are implemented by installing a computer program on a computer to perform the information processing method and by executing the computer program via the computer.

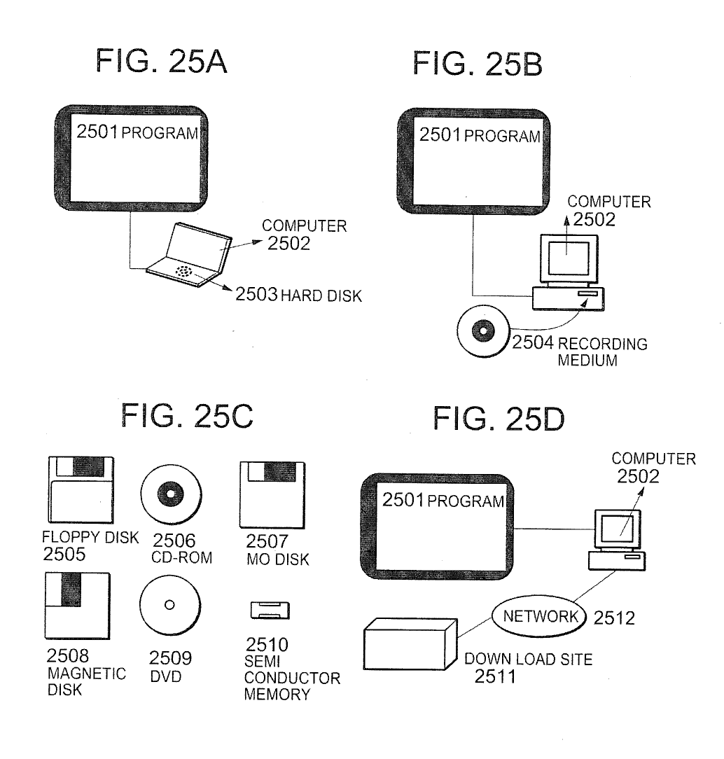

Now referring to FIGS. 25A through 25D, the diagrams illustrate exemplary methods of providing one preferred process of the computer program 2501 according to the current invention to the computer 2502. FIG. 25A illustrates that the program 2501 has been already installed in a hard disk 2503 in the computer 2502 and will be provided to the computer 2502 from the hard disk 2503. FIG. 25B illustrates that the program 2501 is temporarily or permanently stored in a recording medium 2504 and will be provided to the computer 2502 by inserting the recording medium 2504. FIG. 25C illustrates examples of the recording medium 2504, and the examples include a floppy® disk 2505, a compact disk for read only memory (CD-ROM) 2506, a magnet optical disk (MO) 2507, a magnetic disk 2508, a digital versatile disk (DVD) 2509 and a semi conductor memory 2510. FIG. 25D illustrates a download to a computer. The computer program 2501 is wirelessly or otherwise downloaded from a download site 2511 via network 2512 such as intranet or local area network (LAN) or the Internet or wide area network (WAN) to a hard disk 2502 in the computer 2502.

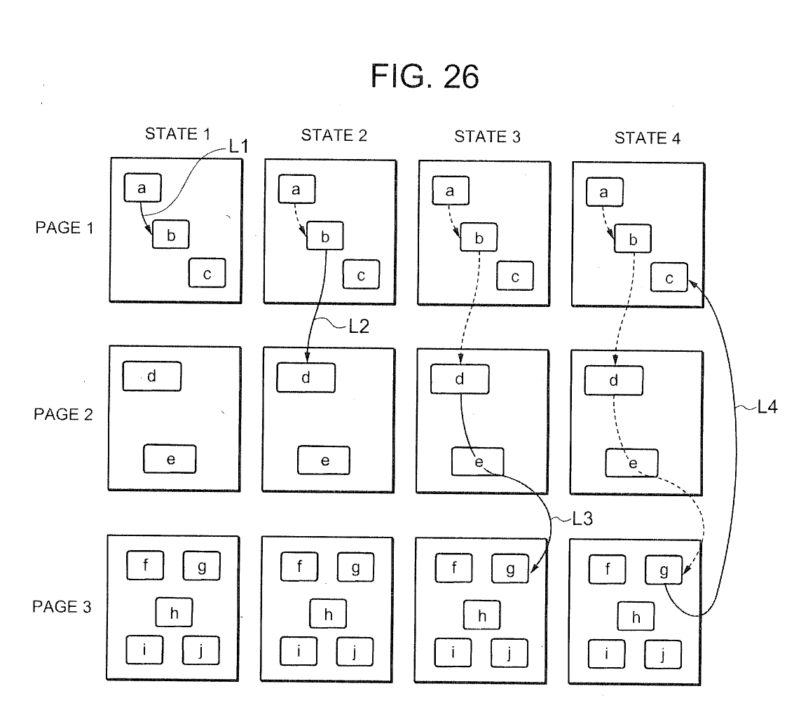

FIG. 26 is a diagram illustrating the directionality of the relational links between the image objects according to the current invention. When the hypertext button 1109 as shown in FIG. 11 is pressed, the GUI provides the facility to generate a directional link from one image object as a link source to another image object as a link destination. For example, the image data has the image objects “a” through “j” over three pages, Page 1, Page 2 and Page 3 as shown in State 1. Also shown in State 1 is a first directional link L1 from the image object a as a link source to the image object b as a link destination. Subsequently, in State 2, a second directional link L2 has been generated from the image object b as a link source to the image object d as a link destination. Similarly, in State 3, a third directional link L3 has been generated from the image object d as a link source to the image object g as a link destination. Lastly, in State 4, a fourth directional link L4 has been generated from the image object g as a link source to the image object c as a link destination. As a result, one can follow

Still referring to FIG. 26, the above example also shows the generation of flexible bidirectional links. The exemplary directional links illustrate links between the image objects both on the same page as shown in State 1 and on different pages as shown in States 2, 3 and 4. Based upon the above generated exemplary directional links, corresponding hypertext structures are also generated. The exemplary hypertext data indicates that the hypertext links are available from the image object a on Page 1 to the image object b on Page 1, the image object d on Page 2, the image object g on Page 3 and the image object c on Page 1. Conversely, the same exemplary hypertext data also optionally indicates the forward as well as corresponding backward links. Based upon the same example, the image object g on Page 3 has a backward link to the image object d on Page 2 and also a forward link to the image object c on Page 1. The he above general concept is applicable to a concrete example of a meeting to generate links between the agenda and the corresponding discussions or between the objects and the conclusions. Between the areas that contain the related information, a link is sequentially made from a link source to a link destination. Thus, the linked related information later reveals how the discussion had progressed during the meeting.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of information processing, comprising the steps of:
inputting on an image drawing surface an image containing at least one image object, a predetermined set of image types being defined for the image objects;
automatically determining an area and a image type for each of the image objects;
displaying a display object for representing each of the image objects;
editing information on the image objects based upon the display object, the information including a directional link from one of the image objects as a link source to another of the image objects as a link destination; and
generating document data for the image according the edited information on the image objects, the image objects and the image type.

2. The method of information processing according to claim 1 wherein said inputting step further comprising the additional steps of:
drawing the image on a board with a marker; and
capturing the image in digital data.

3. The method of information processing according to claim 2 wherein said capturing step is continuous scanning of a portion of the image.

4. The method of information processing according to claim 2 wherein said capturing step is simultaneous digitizing of an entire portion of the image.

5. The method of information processing according to claim 2 wherein said automatically determining step further comprising:
removing noise in the image;
digitizing the image into digitized image data after the noise removal; and
quantizing the digitized image data.

6. The method of information processing according to claim 1 wherein the information includes a label for describing the image object.

7. The method of information processing according to claim 1 wherein the display object includes a label for describing the image object.

8. The method of information processing according to claim 1 wherein the information includes display information of the display objects.

9. The method of information processing according to claim 1 wherein the image objects contain other ones of the image objects.

10. The method of information processing according to claim 9 wherein the display objects are zoomed in and out.

11. The method of information processing according to claim 9 wherein the display objects are individually resized.

12. The method of information processing according to claim 1 wherein the link information specifies a relational link between the images.

13. The method of information processing according to claim 1 wherein the link information specifies a relational link between the image objects.

14. The method of information processing according to claim 1 wherein the information includes an image label.

15. The method of information processing according to claim 1 wherein the document data includes the HTML and the XML.

16. A system for information processing, comprising:
an image inputting unit having a conventional image drawing surface for drawing an image containing at least one image object, a predetermined set of image types being defined for the image objects;
a processing unit connected to said image inputting unit for automatically determining an area and a image type for each of the image objects and for displaying a display object for representing each of the image objects;
an editor connected to said processing unit for editing information on the image objects based upon the display object, the information including a directional link from one of the image objects as a source link to another of the image objects as a destination link; and
a document generating unit connected to said processing unit for generating document data for the image according the edited information on the image objects, the image objects and the image type.

17. The system for information processing according to claim 16 wherein said inputting unit further comprising an image capturing unit for capturing the image in digital data.

18. The system for information processing according to claim 17 wherein said image capturing unit is a scanner for continuously scanning of a portion of the image.

19. The system for information processing according to claim 17 wherein said image capturing unit is a CCD camera for simultaneous digitizing of an entire portion of the image.

20. The system for information processing according to claim 18 wherein said processing unit removes noise in the image, digitizes the image into digitized image data after the noise removal and quantizes the digitized image data.

21. The system for information processing according to claim 16 wherein the information includes a label for describing the image object.

22. The system for information processing according to claim 16 wherein the display object includes a label for describing the image object.

23. The system for information processing according to claim 16 wherein the information includes display information of the display objects.

24. The system for information processing according to claim 16 wherein the image objects contain other ones of the image objects.

25. The system for information processing according to claim 24 wherein said editor zooms the display objects in and out.

26. The system for information processing according to claim 24 wherein said editor individually resizes the display objects.

27. The system for information processing according to claim 16 wherein the link information specifies a relational link between the images.

28. The system for information processing according to claim 16 wherein the link information specifies a relational link between the image objects.

29. The system for information processing according to claim 16 wherein the information includes an image label.

30. The system for information processing according to claim 16 wherein said document generating unit generates the document data in the HTML.

31. The system for information processing according to claim 16 wherein said document generating unit generates the document data in the XML.

32. The system for information processing according to claim 16 further comprising a storage unit for storing the images, the image objects, the display objects and the information.

33. A method of retrofitting a conventional image inputting device for further image processing, comprising the steps of:
placing an image capturing device near the conventional image inputting device;
inputting on an image drawing surface of the conventional image inputting device an image containing at least one image object, a predetermined set of image types being defined for the image objects;
capturing the image in a predetermined digitized data format;
automatically determining an area and a image type for each of the image objects based upon the digitized data;
displaying a display object for representing each of the image objects;
editing information on the image objects based upon the display object, the information including a relational link between the image objects; and
generating document data for the image according the edited information on the image objects, the image objects and the image type.

34. The method of retrofitting a conventional image inputting device according to claim 33 further comprising an additional step of storing the generated document data.

35. The method of retrofitting a conventional image inputting device according to claim 33 wherein the relational link is directional from one of the image objects as a link source to another of the image objects as a link destination
